(19) United States
(12) Patent Application Publication
(10) Pub. No.: US 2020/0380830 A1
(43) Pub. Date: Dec. 3, 2020

(54) WAGERING PLATFORM

(71) Applicant: Patrik KAHARI, Sliema (MT)

(72) Inventor: Patrik KAHARI, Sliema (MT)

(21) Appl. No.: 16/426,379

(22) Filed: May 30, 2019

(51) Int. Cl. G07F 17/32

(52) U.S. Cl. CPC G07F 17/3288; G07F 17/3227

(57) ABSTRACT

A wagering platform may be provided. The wagering platform may utilize a portfolio matrix to provide real-time wagering odds based on game parameters and outcome selections. Furthermore, the wagering platform may automatically generate and transmit a wagering slip. The wagering platform may additionally facilitate previewing and placing combination wagers.

### BACKGROUND

Wagering on future outcomes has been a game of chance practiced by humans throughout their existence. Specifically, wagering has prominently centered around sport and athletic competition. Furthermore, gamblers regularly place wagers on multiple outcomes in a single game or multiple outcomes spread across multiple games in order to spread or minimize risk. Throughout history, a person's wagers and risk spreading typically had to be managed using complex calculations or approximations, when such calculations were impractical. In some situations, different wagering services are required for different wagers, which impedes managing wagers and the associated risk.

In wagering, particularly in the field of sports, a game may be a specific sports game or match on which a bookmaker provides bets or wagers. The bookmaker may allow wagering in various circumstances. For example, a bookmaker may only allow betting until the start of a game (“pre-live betting”), or also while the game is in-play (“live-betting”). For each game, a bookmaker may allow betting or wagering on a number of different markets. Markets may include, for example, “money line,” “handicap,” “total goals/points,” “winner,” and “correct score.” A market may define specific metrics, the outcome of which constitutes a wager. For example, a market may define a metric as a score, number of corner kicks, or number of red/yellow cards and the market may further define at what time the metric is measured, for example, at the end of a game or when the next goal is scored. A market may define the set of all possible outcomes or sample space. Conventionally, bookmakers organize betting into completely independent markets and each market may have distinct outcomes that cannot be meaningfully compared to the outcome of other markets. Therefore, conventional platforms may not provide for summarizing or combining bets into a larger group, as the outcomes may be fundamentally different. For example, a bet on a market “Full Time Score” and a bet on a market “Over/Under 1.5” may be seemingly unrelated. The outcome 1-1 on a Full Time Score market may seem incomparable to an Over 1.5 outcome. Therefore, it may be desirable for a platform that may allow for meaningful integration of individual markets.

As a game progresses, the set of possible outcomes may be reduced. For example, once a goal is scored, the correct score outcome “0-0” may no longer be possible. Bets on such outcomes can be settled early and once a measurement is done, the market may be reduced to a single outcome, allowing bets on that outcome to be settled. The market may define the rules, terms, and conditions of a bet on that market. For example, the rules for a “winner market” bet may allow settlement in a different manner from an “Asian handicap” bet. A “winner market” may settle as a loss or win for the bettor, while an “Asian handicap” bet may settle as a win, loss, half win, or returned stake, for example. Furthermore, different bookmakers may set different rules for similar markets, including for settlement of bets or when a bet may be voided.

Each market may have a set of possible outcomes. For example, a money line market may include the outcomes “home team win” and “away team win.” A handicap market may include exemplary outcomes “+1.5 home win” and “−1.5 away win.” A total goals or total points market may include the outcomes “over 2.5” and “under 2.5.” A winner market may include the outcomes “home team win,” “draw,” and “away team win.” A correct score market may include outcomes “0-0,” “0-1,” “1-0,” “1-1,” . . . , “n-n.”

A bet may be defined as an agreement between a bettor or buyer and a bookmaker or seller. It may be required that both parties, the bettor and bookmaker, must accept a bet for the bet to become binding. A bettor may accept a bet by placing or sending the bet and a bookmaker may accept by matching the bet. In some bets, a bettor may pay an upfront amount or wager called a stake. If an outcome happens, a bookmaker may pledge to pay back a certain amount based on odds. A bet may include a combination of several elements. Bet elements may include the game on which to bet, the market on which to bet, the chosen outcome(s) on which to bet, the stake amount to bet (upfront amount a bettor pays to a bookmaker), and the payout amount if a chosen outcome occurs (paid by bookmaker to bettor). A ratio of the stake to the payout is called the “odds.” Odds may be quoted in different formats, such as fractional, decimal, money line, percentage or other formats as desired; however, the fundamentals of odds may remain the same. The stake may be a variable that the bettor can choose. There may be limits placed on the stake. The bettor may also be allowed to choose odds in some circumstances. Generally, the payout may be determined or calculated from the stake and the odds rather than being a variable chosen by the bettor; however, that is not always the case.

A bet may further progress through a number of states, such as, “drafted,” “placed,” “revoked,” “matched,” and “settled.” A bet may experience some or all of these states and in some circumstances additional states may be contemplated. The states may be merged or subdivided. In a drafted stage, a bettor may have prepared a draft bet by choosing or modifying values or metrics, such as, but not limited to, a chosen outcome, stake and odds. A bookmaker may help prepare a bet by, for example, modifying odds in real-time. In a placed stage, a bettor, being satisfied with the draft bet, may have placed the bet or sent the offer to a bookmaker. By placing a bet, a bettor may accept that the bet may become binding once matched by a bookmaker. In a revoked stage, a bettor may have been given the opportunity to revoke or cancel a placed bet. Typically, a placed bet may only be revoked if it has not been matched or accepted. Bookmakers may optionally not allow revocation of bets. Similarly, exchanges may optionally allow revocation of bets. A bookmaker may directly accept bets from a bettor. An exchange, on the other hand, may allow bets to be matched among bettors. Therefore, a bet placed on an exchange can be matched by another better and the exchange may earn a commission on the bet.

Furthermore, a bet may be matched or rejected. If a bet is accepted by a bookmaker, the bet may be matched. A matched bet may form a binding agreement with fixed values that cannot be changed by either party. A bookmaker may accept or reject a placed bet immediately or after time has passed. A bookmaker may delay to protect against a bettor having real-time information. When a bet is placed to an exchange, the bet may remain as placed or as an open offer until the game or market ends, another party accepts, or the bettor revokes the placed bet. A bet may be rejected for any reason, including the odds or stake not being acceptable. Finally, a bet is settled or refunded. Once the game or market ends and the actual outcome is known, the bet(s) may be settled. Bets on winning outcomes may result in a payout to a bettor, while bets on losing outcomes may result in the bookmaker retaining the stake. In certain circumstances where settlement cannot be accomplished, a bet stake may be refunded to the bettor and the bet may be considered void. Rules for refunding a bet may optionally be set forth as terms of the bet and may happen, for example, if a game is canceled or technical difficulties are encountered.

Bettors may place numerous bets on a single game or match and may have no way to view or assess bet history, including profits or losses, and outstanding risk for a match. Furthermore, a bettor may not understand which outcomes corresponds to a market. For example, a bettor may not know which score outcomes correspond to a bet on “4.5 Goals” or “Asian Handicap Home −0.25.” While traditional betting may provide for a multiples bet, which may only be won if all included bets are winning bets (an ALL-combo bet), traditional betting may not allow for a combined bet with single odds (ANY-combo bet, as described herein), which does not require all included bets to be winning bets. In other words, a bettor may not be able to place a bet on a number of outcomes as a single bet with single odds. Traditional betting may also not provide a platform that allows previewing a draft bet and how a draft bet will affect risk. Lastly, traditional betting may not allow for cashing out a portfolio, cashing out a percentage of a portfolio, or buying more of a portfolio. For example, traditional betting may not allow for cashing out half of each of a bettors matched bets or alternatively buying 25% more of each of the bettor's matched bets. It therefore may be desired to have a platform for managing wagers that provides this functionality.

### SUMMARY

According to an exemplary embodiment, a non-transitory computer-readable medium for managing wagers with instructions stored thereon may be provided. When the instructions are executed on a process, the following steps may be performed. A matrix may be generated for a game. The matrix may include individual cells, which represent possible outcomes of game events. The matrix may be displayed through a user interface. Odds may be calculated for the occurrence of at least one outcome. An input of a selection of at least one cell may be processed in addition to the input of a stake. From the selection, stake, and odds, a profit or loss for each outcome may be calculated. The profit or loss for each outcome may be presented in a respective cell. The odds for a selection may be processed and presented. Furthermore, a bet slip may be created and may include at least one bet selection. Upon processing of a place bet instruction, a bet may be placed according to the bet slip and a placed bet record may be created.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

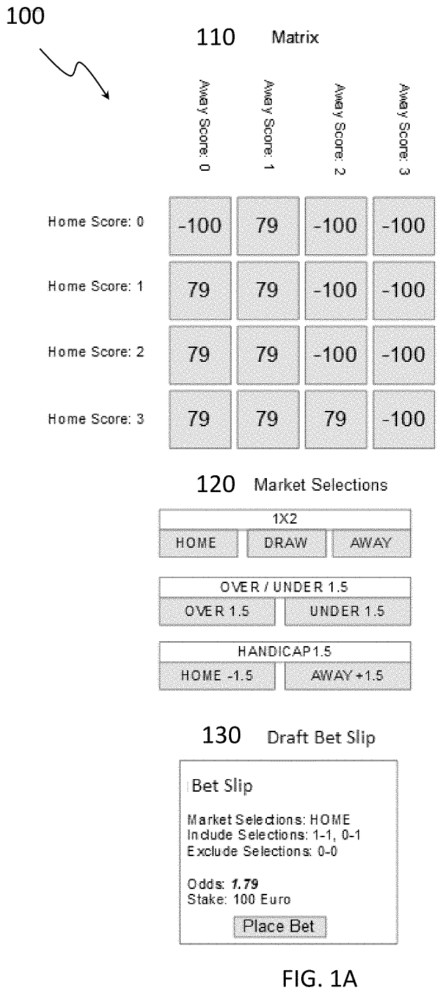

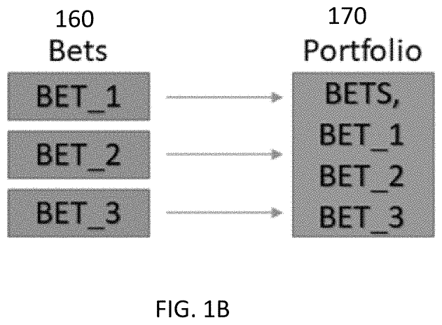

Exemplary FIG. 1A shows a wagering platform matrix;

Exemplary FIG. 1B shows a wagering platform bet portfolio diagram;

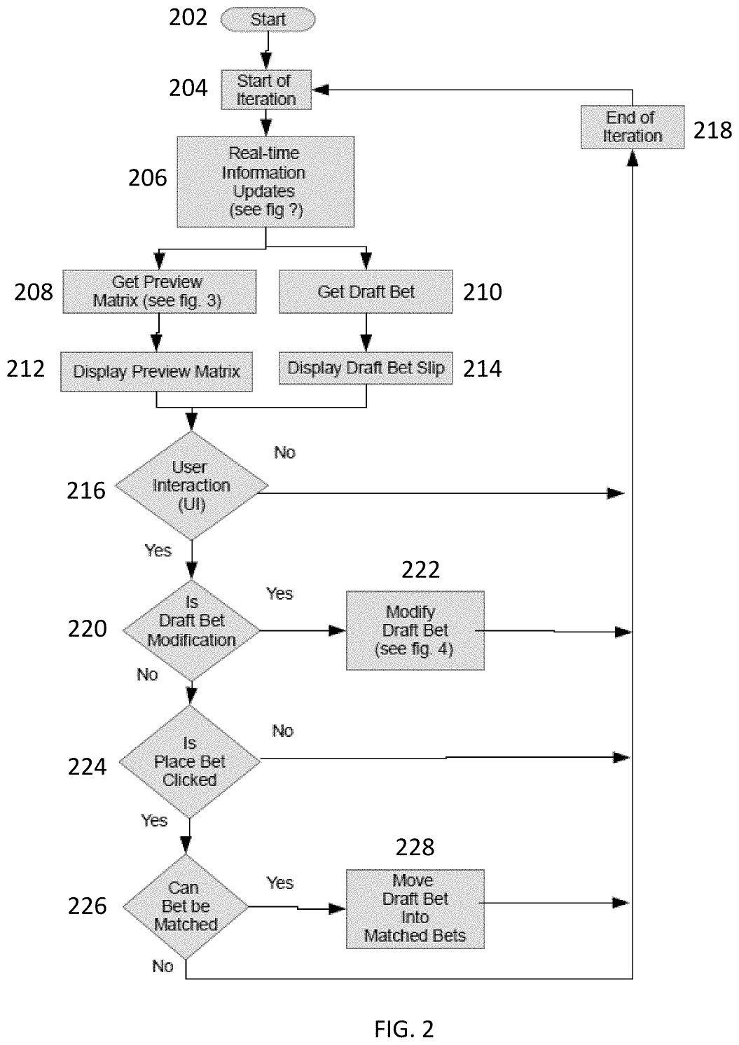

Exemplary FIG. 2 shows a wagering platform flowchart;

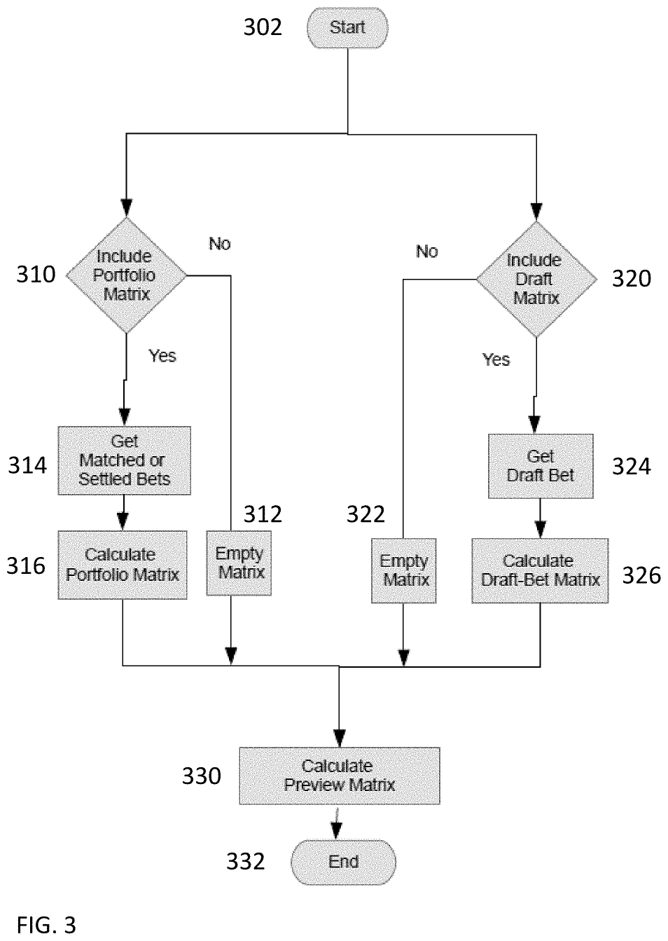

Exemplary FIG. 3 shows a flowchart for generating a matrix;

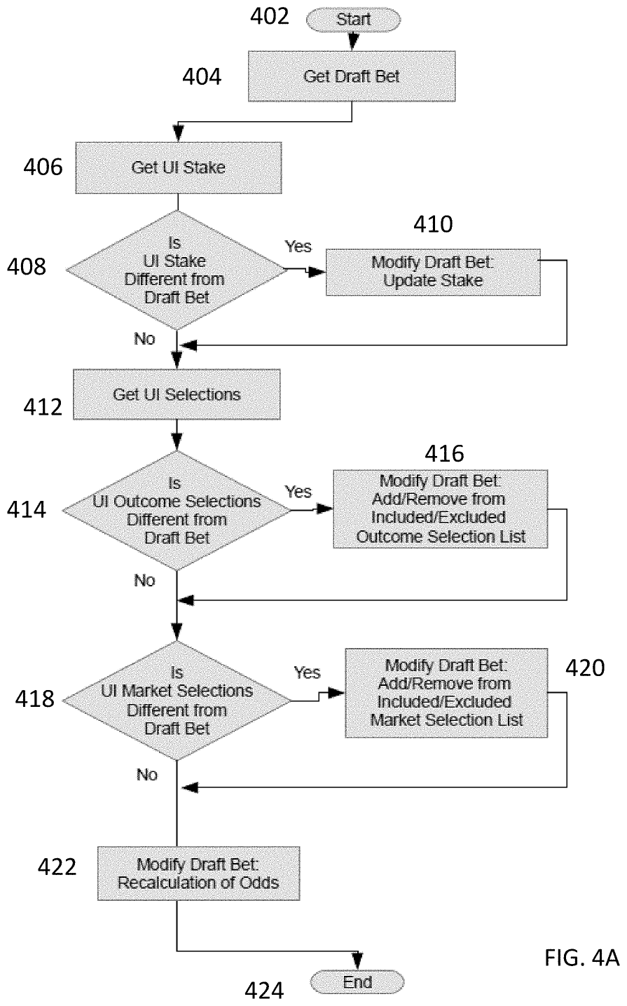

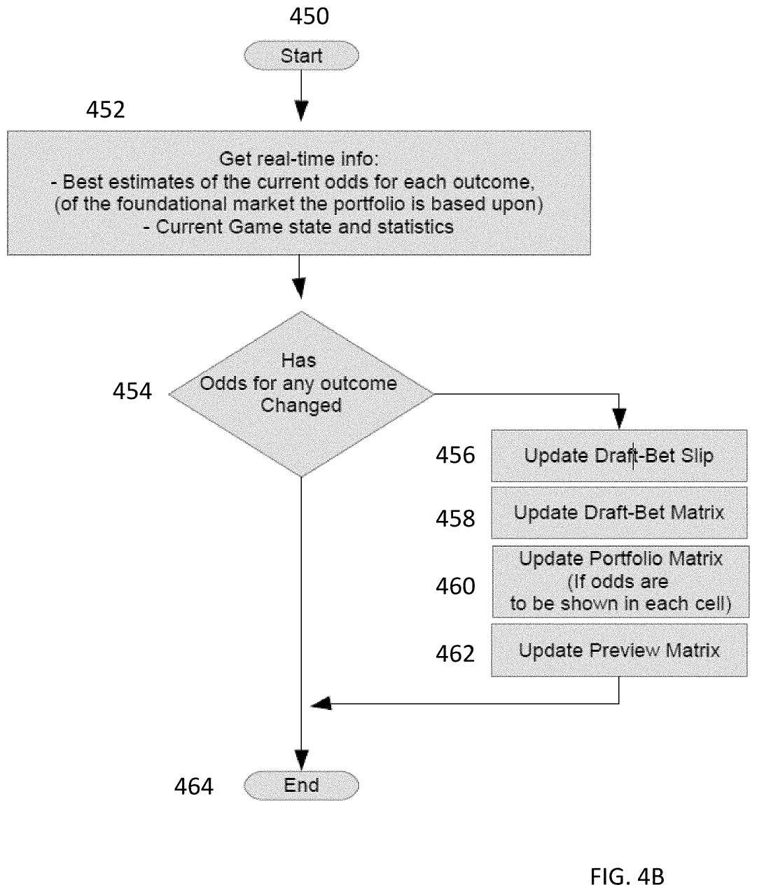

Exemplary FIG. 4A shows a flowchart for modifying a draft bet;

Exemplary FIG. 4B shows a flowchart for updating information in real-time;

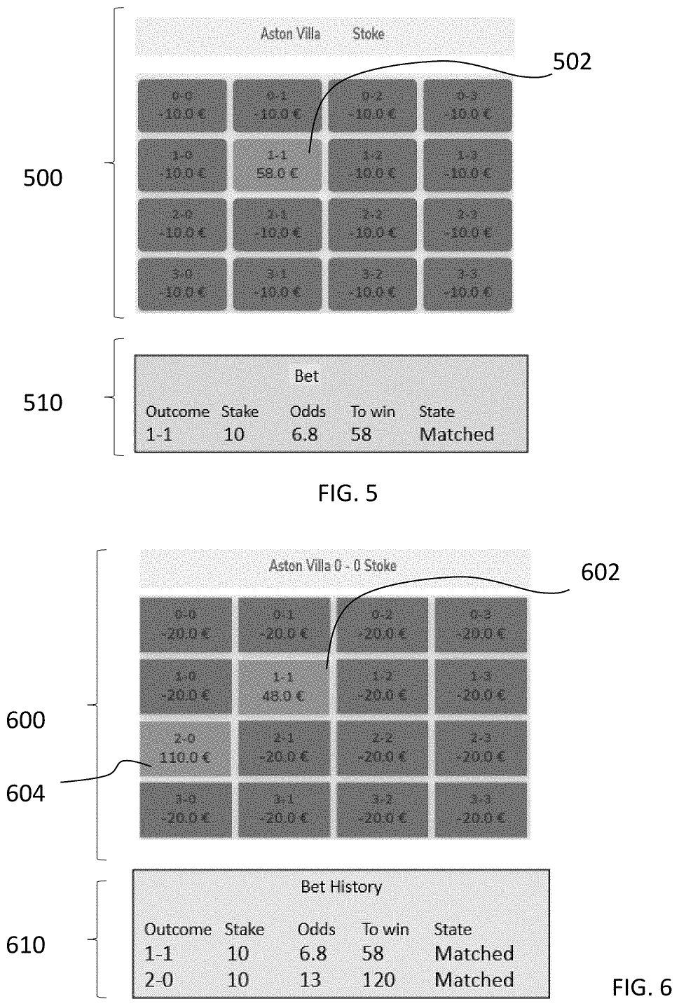

Exemplary FIG. 5 shows a single-bet matrix;

Exemplary FIG. 6 shows a portfolio matrix;

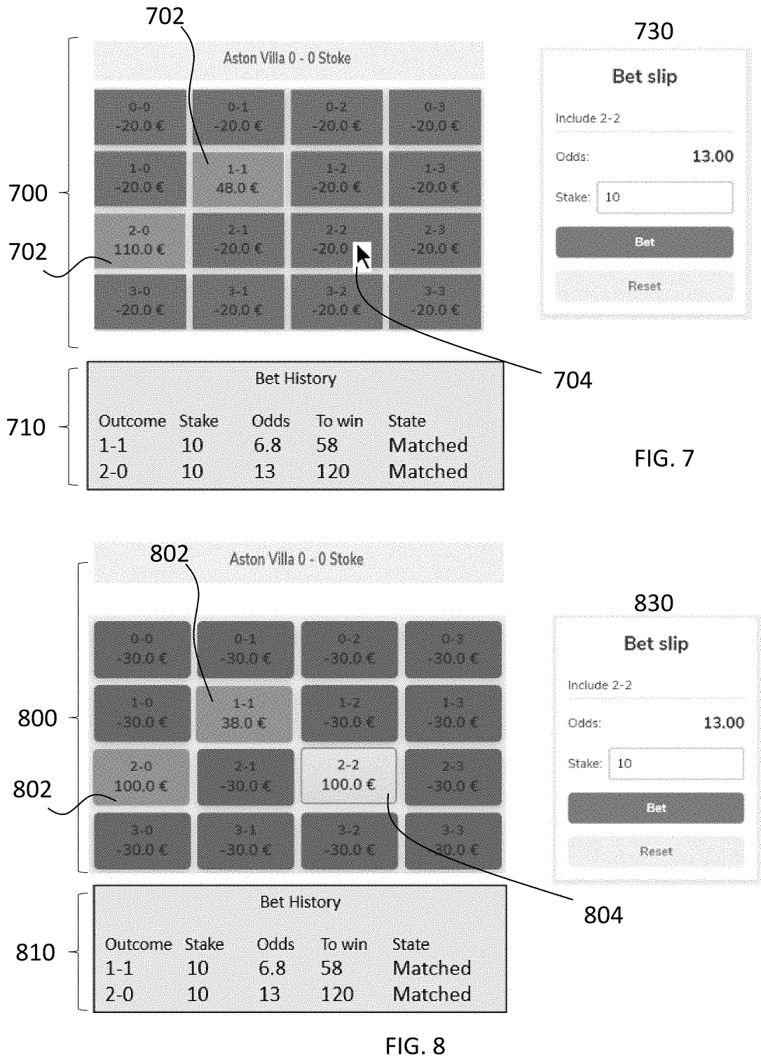

Exemplary FIG. 7 shows a portfolio matrix with a single draft bet selection;

Exemplary FIG. 8 shows a single outcome draft bet in a preview matrix;

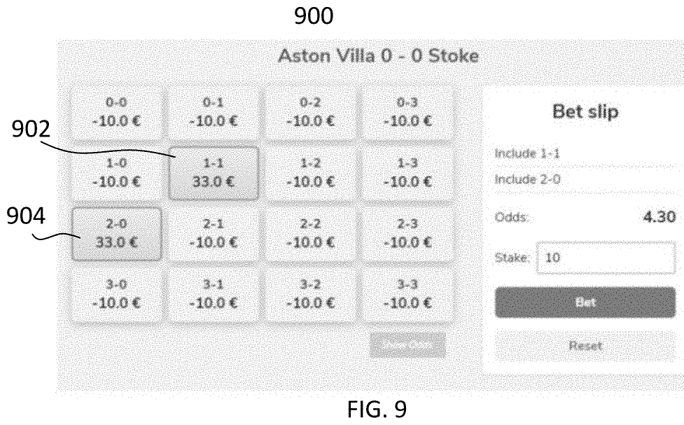

Exemplary FIG. 9 shows a multiple outcome draft bet in a preview matrix;

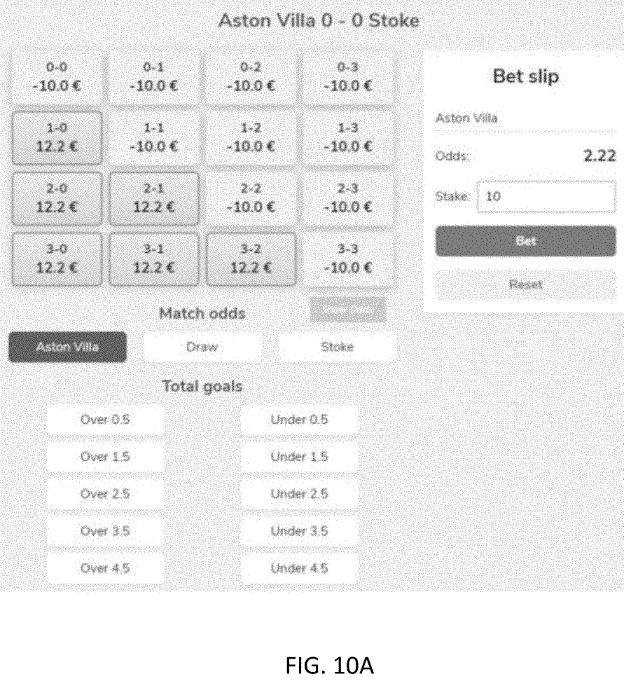

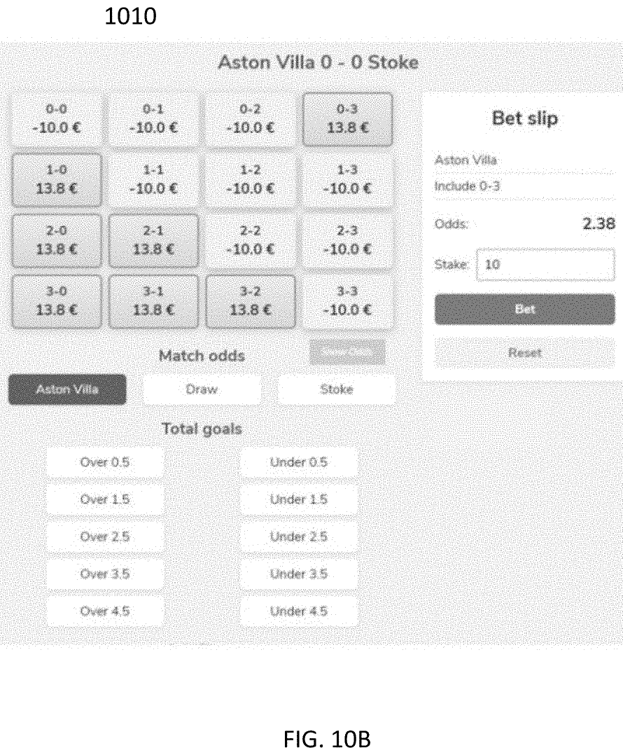

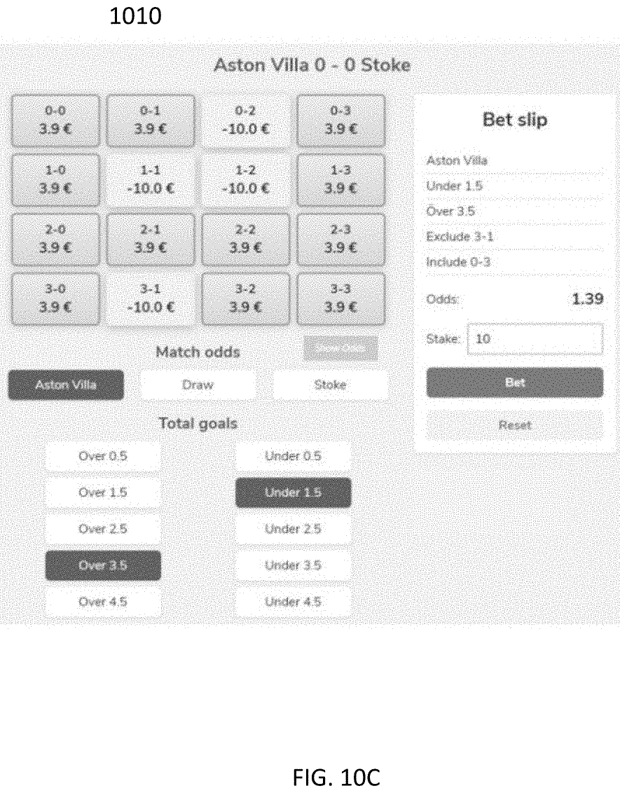

Exemplary FIG. 10A shows a single market shortcut draft bet in a preview matrix;

Exemplary FIG. 10B shows a multiple outcome market shortcut draft bet in a preview matrix;

Exemplary FIG. 10C shows a multiple outcome market shortcut draft bet in a preview matrix with additions and exclusions;

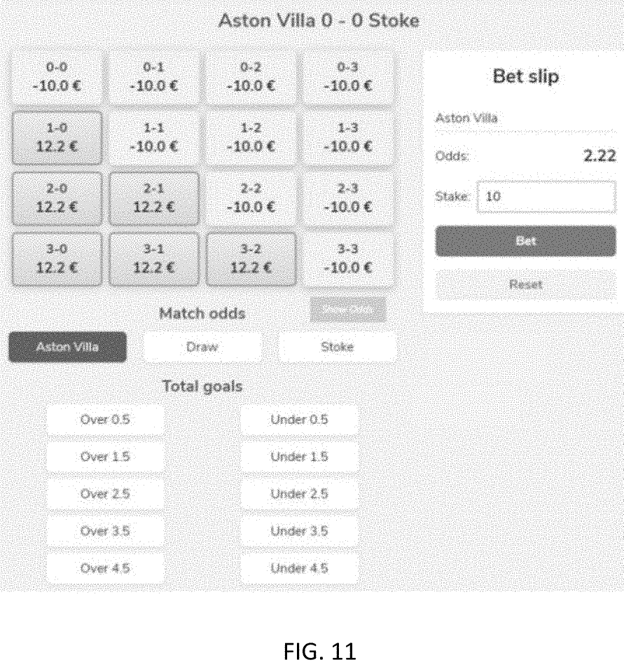

Exemplary FIG. 11 shows a draft-bet matrix;

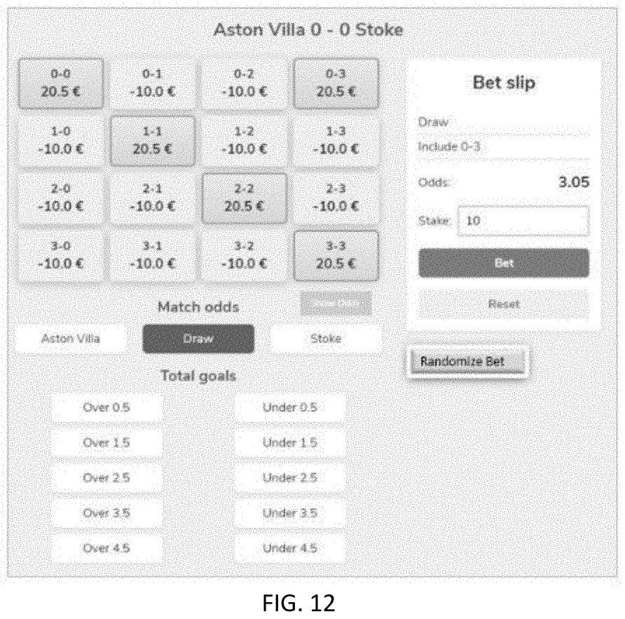

Exemplary FIG. 12 shows a market shortcut draft-bet matrix with a randomized individual outcome bet;

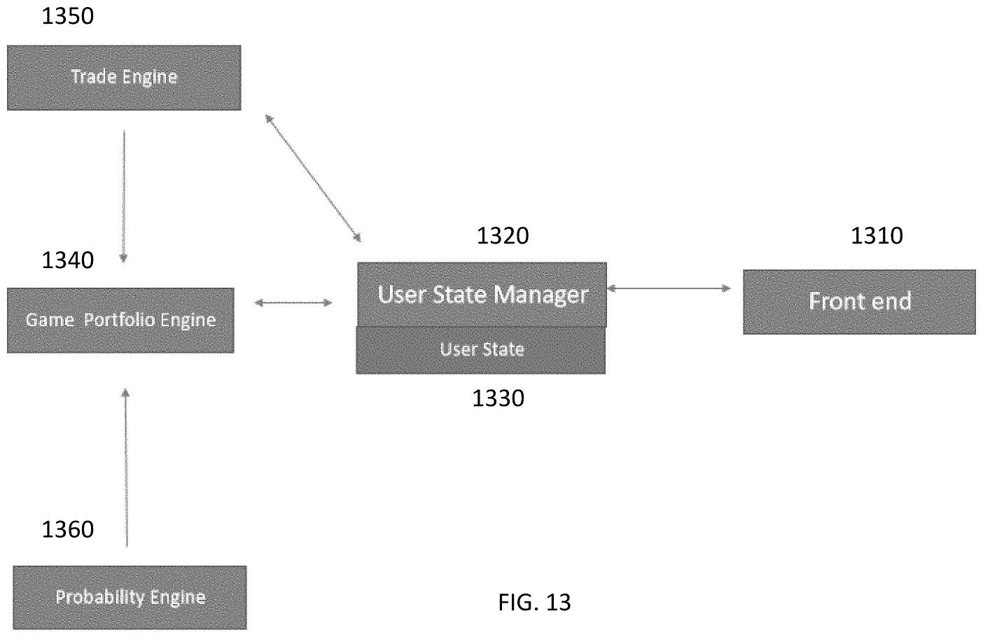

Exemplary FIG. 13 shows a wagering platform component diagram;

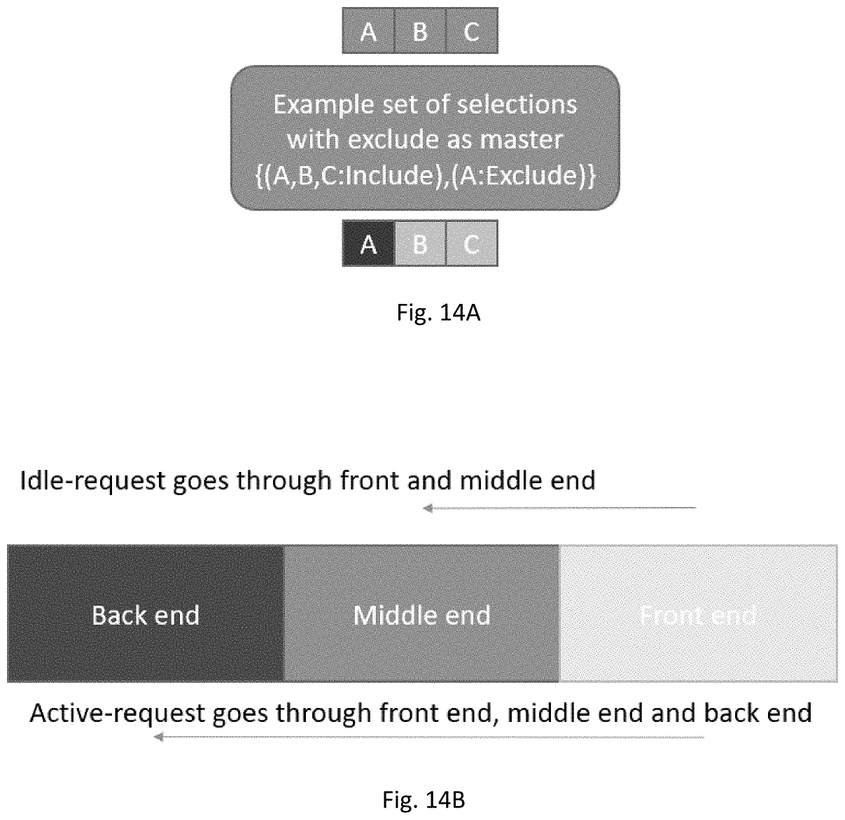

Exemplary FIG. 14A shows a wagering platform selection diagram;

Exemplary FIG. 14B shows a wagering platform stage diagram;

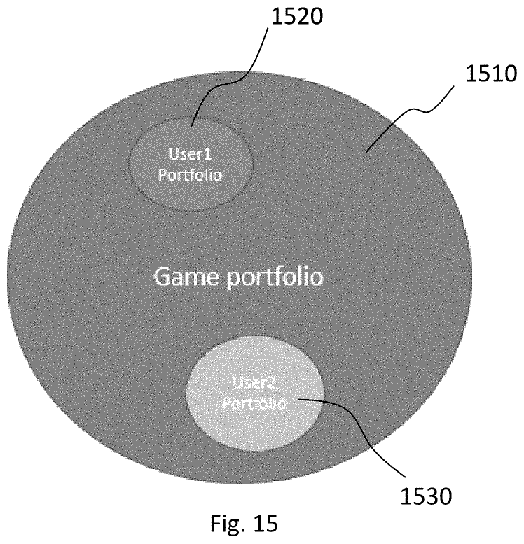

Exemplary FIG. 15 shows a game portfolio diagram;

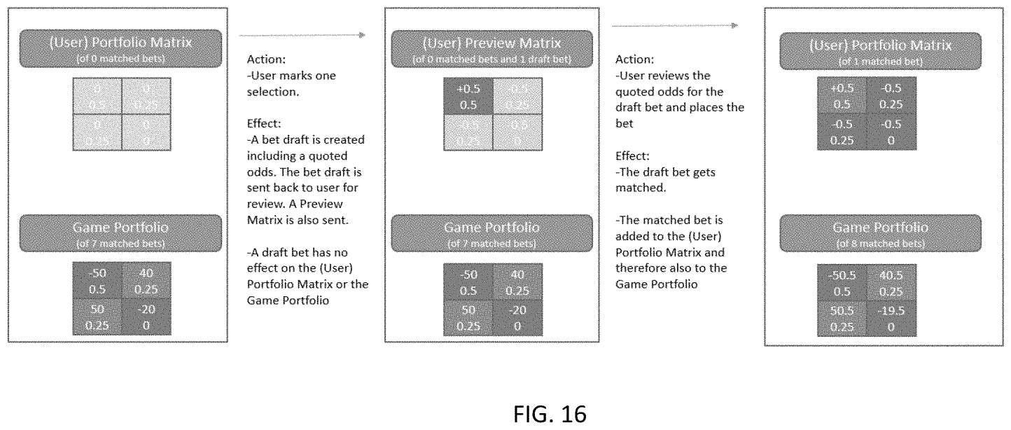

Exemplary FIG. 16 shows a wagering platform individual outcome selection flowchart;

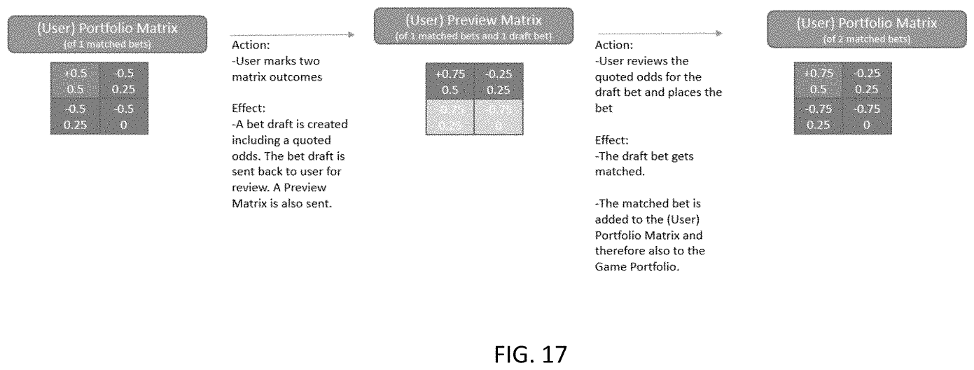

Exemplary FIG. 17 shows a wagering platform multiple bet selection flowchart;

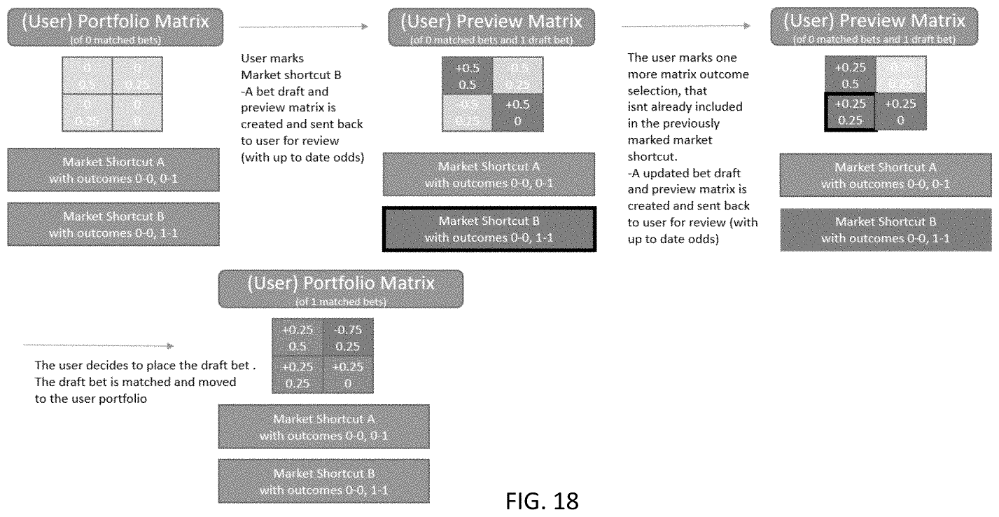

Exemplary FIG. 18 shows a wagering platform market shortcut selection flowchart; and

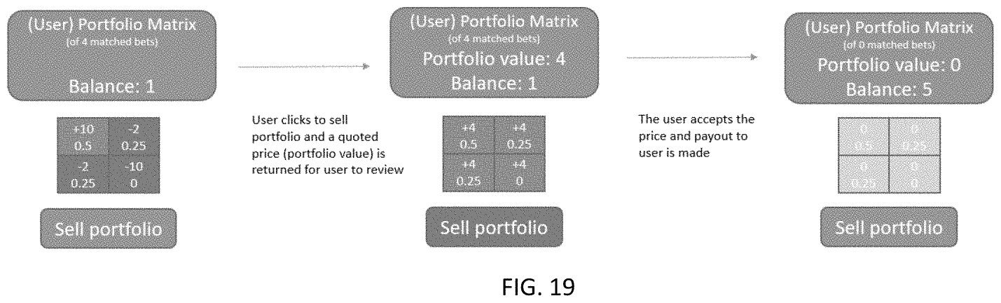

Exemplary FIG. 19 shows a wagering platform sell portfolio flowchart.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

Wagering Platform Introduction

Referring to the Figures generally, a wagering platform may be provided for managing wagers and associated risk. According to an exemplary embodiment, the wagering platform may utilize a matrix to display and manage risk and may additionally process individual and combination bets through one or more matrices. For purposes of explanation, exemplary metrics used herein may relate to a football or soccer match; however, this should be viewed as exemplary and corresponding or unique metrics for other sports may be understood by a person having ordinary skill in the art. Furthermore, the numbers used throughout the description may be exemplary in nature, as would be understood by a person having ordinary skill in the art. Each specific measurement may be an outcome.

According to an exemplary embodiment, a matrix of the wagering platform may include a number of columns and rows forming a number of individual cells. Each cell may represent a possible matrix outcome of one game. A matrix may be calculated from a set of one or more bets of a bettor. Each matrix cell may optionally display a profit for the bettor if the matrix outcome occurs and a loss if the outcome does not. In a basic matrix, matrix outcomes may match a “correct score” market. The columns of the matrix may correspond to a home score and the rows may correspond to an away score. Individual cells may correspond to the correct score outcomes.

In some situations, outcomes for a market may be based on the outcomes of other markets. For example, a “home team win” outcome in a winner market may be based on a correct score market outcome of where home score > away score, such as “1-0,” “2-0,” “2-1,” . . . , “home score-away score.” Based on the inherent relationship of market outcomes, certain markets may be considered foundational markets, upon which other supplemental markets may be based. For example, a correct score market, first-half score market, throw-ins market, first-half throw-ins market, or other markets, including unique markets for specific games may be considered foundational markets. Foundational markets may be different from each other because the measurement metric may be different (score, throw-ins, red/yellow cards, etc.) or because the time of the measurement may be different (at full-time, half-time, at the time of the next throw-in, etc.).

In an exemplary embodiment, many supplemental markets may be based on a foundational correct score market. Therefore, the additional bets in supplemental markets may still be summarized in a correct score matrix. However, as detailed herein, certain markets may not be based on a foundational correct score market. Therefore, certain bets based on alternative foundational markets may need to be summarized in separate matrices. Additional correct score matrices for each period of a game, for example, may cover other markets that are not founded in the total correct score market. Other separate matrices may include a variety of foundational game parameters, such as throw-ins, red/yellow cards, or other parameters as would be understood by a person having ordinary skill in the art. The foundational and supplemental markets may be unique to a particular match or game type.

Furthermore, a wagering platform may facilitate leveled functionality, which may allow for analysis, processing, and transactions to build on lower level analysis, processing, and transactions. At an initial level, a bet or portfolio matrix may be provided for presenting risk based on a betting preview or betting history (portfolio matrix). A portfolio matrix may account for a bettor's risk by showing profit and loss of each individual outcome and odds for a selection of bets and/or single bets. Additional levels of analysis, processing, and transactions may become apparent from the description of various embodiments provided herein.

According to an exemplary embodiment, odds or probabilities for each outcome in a game may be determined using a number of conventional methods. For example, they may be estimated, purchased from an outside live price feed provider, calculated based on simulations, determined through the use of Markov chains or Poisson distributions. Furthermore, the odds may be risk adjusted.

The wagering platform may facilitate decomposing seemingly distinct markets into common fundamental or foundational markets. This may allow for bets on many seemingly different markets, which can be reduced to the same fundamental market, to be placed in the same portfolio. The platform may provide for representing and displaying the portfolio having bets and data from many seemingly different markets as a matrix. Furthermore, the platform may provide for the placement of bets through the matrix. A portfolio may include a probability component and a list of bets. A portfolio may be restricted to a single foundational market. However, multiple markets based on the same foundational market may be included in a portfolio. The probability component may hold all probabilities for outcomes in a foundational market, which may sum to one:

$$Probc = {\sum }_{probx}^{prob 0} p = 1.$$

The list of bets in a portfolio may be a structure that holds all placed bets on a foundational market. The expected value of a portfolio may be derived according to the following, where b is a bet constituting one or more outcomes:

$$Exp ( Portfolio ) = {\sum }_{betx}^{bet 0} {\sum }_{probx}^{prob 0 } bet * prob .$$

The expected value for a user may be derived by selecting its associated bets.

In other words, the platform may allow for different conventional markets to be deconstructed into foundational markets with foundational outcomes. Many different markets may share a common foundational market. Once conventional markets have been deconstructed into foundational markets, bets on these markets may be grouped together in portfolios containing markets based on a common foundational market. There may be multiple portfolios per person or per game and each portfolio may be managed as a matrix through the platform.

Now referring to exemplary FIG. 1A, exemplary display elements of a wagering platform interface 100 may be provided. The interface elements may include a portfolio matrix 110, which may provide a matrix of individual outcomes for a game. Interface 100 may further include market selections 120, which may place market shortcut bets, as described herein. Furthermore, interface 100 may include a bet slip or bet ticket 130, which may preview a draft bet. Furthermore, the wagering platform may facilitate placing bets using the matrices generated and presented through the platform. When a number of selections are made through the wagering platform, the selections may be placed as single bets or optionally as a single combination bet with odds generated based on the aggregate of individual selections. The combination bet may be an ANY-combo bet or an ALL-combo bet, as defined in more detail herein. Furthermore, referring to FIG. 1B, a bet portfolio may consist of one or more bets. For a particular game, for a single user, all bets 160 on the same foundational market may be placed in a portfolio 170. The portfolio 170 may be priced in real-time, which may allow a user the option to buy more of the portfolio 170 or sell parts or the whole portfolio 170 regardless of how many wagers have been placed throughout the lifetime of the game or event. Each bet 160 may include an arbitrary set of outcomes and the portfolio 170 may merge all bets into a single collection, from which a single aggregate probability for the sum of all of the bets 160 or the whole portfolio 170 may be derived.

Now referring to exemplary FIG. 2, a flow chart for a platform for managing wagers or bets may be provided. The platform program may be initiated 202 and a betting iteration may be started 204. Real time updates of betting parameters and information may be loaded 206, according to FIG. 4B. A preview matrix may be calculated and generated 208 (pursuant to FIG. 3). A draft bet may be received or processed 210 from a user interface or may be transmitted from an external source. The preview matrix may be displayed 212. A draft bet slip may also be displayed 214 showing the draft bet. The platform may then detect and process user interaction 216. If no user interaction is detected, there may be no valid bet and the betting iteration may end 218. If user interaction is detected such as by clicking on an interface, it may be determined whether the user interaction is a draft bet modification 220, such as a new outcome or market selection or removal. If a selection is further clicked or otherwise engaged, a draft bet may be modified 222, as detailed in FIG. 4. If a draft bet is modified 222, the betting iteration may end 218 and may be restarted with the modified draft bet 204. If a selection is not further clicked or engaged, the platform may detect whether a place bet selection 224 has been engaged through an interface. If no, a bet may not be placed and the iteration may end 218. If yes, a bet may be processed and it may be determined whether the bet can be matched 226. Placed bets may be processed by the wagering platform or may be transmitted to third party entities, such as third-party bookmakers, for matching purposes. If the bet cannot be matched, the iteration may end 218 for that bet. If a draft bet is matched, the draft bet may be updated to a matched bet 228 and may be moved to a matched bet database.

Generating a Matrix

Now referring to exemplary FIG. 3, a matrix may be generated by the wagering platform and may be specific to a user, portfolio, and game. According to an exemplary embodiment shown in FIG. 3, the matrix may be a preview matrix. The platform may determine whether to include portfolio matrix data 310. If no portfolio matrix is to be included, an empty matrix 312 may be input. If a portfolio matrix is to be included, matched or settled bets may be retrieved 314 and a portfolio matrix may be calculated 316 based on the matched and settled bet data. The platform may further determine whether to include draft-bet matrix data 320. If no draft-bet matrix is to be included, an empty matrix 322 may be input. If a draft-bet matrix is to be included, draft bets may be retrieved 324 and a draft-bet matrix may be calculated 326 based on the draft-bet data. A preview matrix may be calculated 330 based on the portfolio matrix and draft-bet matrix inputs. The matrix generation process may end 332 and the calculated preview matrix may be displayed through the wagering platform.

In embodiments where only a portfolio matrix showing matched bets is desired, steps 320-326 may be skipped and the calculated portfolio matrix 316 may be presented. Similarly, a draft bet matrix limited to draft bets may be calculated. The platform may skip steps 310-316 and the calculated draft-bet matrix 314 may be presented.

Modifying a Draft Bet

Now referring to exemplary FIG. 4A, a process for modifying a draft bet through the wagering platform may be provided. The draft bet modification may be initiated by instructions provided to a processor, such as by a user interface 402. A draft bet may be retrieved 404. A user interface (“UI”) stake selection 406 may be retrieved from a user interface. It may then be determined whether the UI stake is different from the stake of the existing draft bet 408. If the stake differs, the draft bet may be modified to update the stake 410 before retrieving UI selections 412. If the stake does not differ, the UI bet selections may be retrieved 412 without first updating the stake. Next, it may be determined whether outcome selections from the UI are different from the draft bet selection 414. If yes, the draft bet may be modified 416 to add or remove selections from the included or excluded outcome selection list to match the UI selections before proceeding to a market selection determination 418. If no, the modification process may proceed to a market selection determination 418 without first modifying the outcome selections. In the market selection determination 418, it may be determined whether market selections from the UI are different from the draft bet selection 418. If yes, the draft bet may be modified 420 to add or remove from the included or excluded market selection list to match the UI selections, before recalculating odds of the draft bet 422 based on the modifications. If no, the odds may be recalculated for the modified draft bet 422. The draft-bet modification process may end 424 and a modified or updated draft-bet record may result, which may be further utilized through the platform.

Real-Time Information Updates

Now referring to exemplary FIG. 4B, a process for real-time information updates by the wagering platform may be provided. A wagering platform may initiate a real-time update 450. Real-time info, including for example best estimates of the current odds for each outcome (of the foundational market the portfolio is based upon), current game state data, and current game statistics may be retrieved 452 for utilization by the platform. From the retrieved real-time information, it may be determined whether the odds for any outcomes have changed 454. For example, odds may be affected by whether an outcome is no longer possible, whether an outcome has already been met, or whether an outcome is more or less likely based on current game parameters, such as score, time remaining, etc. If odds for any outcome have changed, a draft-bet slip may be updated 456, a draft-bet matrix may be updated 458, a portfolio matrix may be updated (if odds are to be shown in each cell) 460, and a preview matrix may be updated 462. A real-time update may end 464 if no changes are determined or once all changes have been incorporated.

A matrix, at any stage as described herein, may be displayed in full or part. If shown in part, the part may be referred to as the “active view” and may optionally be zoomed. The active view may be maneuvered through horizontal and/or vertical scrolling in addition to increased or decreased zoom. Furthermore, the relationship between the full view matrix and the active view may be visualized in a thumbnail on a display. For example, the full matrix may be displayed in a thumbnail with the active view or a border thereof highlighted within the full matrix. In further embodiments of matrices, the score and elapsed time of a game may be shown. In some embodiments, the individual cells of a matrix may optionally show profit or loss, odds (in any format) for the outcome of that cell. In some embodiments, the profit or loss may not be shown, but text or color may identify winning outcomes from losing outcomes. When circumstances of a game narrow or settle possible outcomes to one matrix outcome, the cell representing the final outcome may be highlighted or otherwise outlined, as would be understood by a person having ordinary skill in the art. As game occurrences happen, an active view may automatically adjust to only show outcomes that are still possible. For example, in a correct score matrix, the active view may adjust to no longer show outcomes less than the current score, which have become ruled out due to the current score of the game.

A matrix may further optionally include color, which may be adjusted in real-time to distinguish cells, for example, but not limited to green for profit, red for loss, gray for neutral or unplayed and yellow for draft selections. Grids between cells may optionally be visible or not visible, column and row labels may optionally be displayed, and outcomes may optionally be displayed in each cell or may be determined through column and row labeling. Column and row sizes may optionally be variable, such that, for example, columns and rows are narrower and shorter close to the edge of the matrix, which may result in more of the matrix being visible in an active view. The matrix may be displayed in a diagonal or isometric grid, the matrix may be projected onto 3D objects, such as a sphere or cube. The cells in a matrix may be displayed as textual elements in a 1-dimensional list. The cells may optionally be inset or protrude, forming a 3-dimensional graph. Additionally, the cells in the matrix may be displayed as various shapes, such as, but not limited to, a rectangle, a circle, a triangle, a pentagon, or other polygon as would be understood by a person having ordinary skill in the art.

### Matrix Stage Embodiments

Matrices may be calculated from a set of bets. Therefore, it may be advantageous to group bets based on bet stages or states and to calculate, generate, and present a matrix for the grouped bets. For example, a single-bet matrix may generate and present profit or loss for a matched or settled bet for each matrix outcome. A draft-bet matrix may be used to generate and present the profit or loss for a draft bet for each matrix outcome. A portfolio matrix may generate and present the profit or loss for each matrix outcome for all matched or settled bets that have the same foundational market. Therefore, different portfolio matrices may be used to show bets on different foundational markets, such as halftime score, fulltime score, full time corners, etc. A preview matrix may generate and present the profit or loss for all matched and settled bets plus one draft bet. In other words, a preview matrix may combine a portfolio matrix and a draft-bet matrix.

Single-Bet Matrix

Now referring to exemplary FIG. 5, a single-bet matrix 500 may be provided. Single-bet matrix 500 may display a matched bet as a matrix with profit and loss for each matrix outcome. Single-bet matrix 500 may allow a bettor to easily visualize and conceptualize markets on which a single bet is placed. A single-bet matrix may be presented through the platform when a user selects a bet from a list of matched, settled, or voided bets. The single-bet matrix may allow a user to view and analyze the single bet in isolation. For example, a single bet 501 may be selected and highlighted in the single bet matrix 500. Bet parameters and information may be provided in a bet window 510 for the single bet selected.

Portfolio Matrix

Now referring to exemplary FIG. 6, a portfolio matrix 600 may be provided. A portfolio matrix may include features as described herein with regard to other exemplary matrices. When a bettor has multiple bets on a game, it may be impossible to process or otherwise calculate or conceptualize the total profit or loss risk. This may be especially true if bets have been placed on different markets. A portfolio matrix 600 may provide a profit loss summary of a bettor's bet history and an understanding of the bettor's risk for a match. Only bets with the same underlying foundational market may be presented in the same portfolio matrix. Therefore, multiple portfolio matrices may be available for a game, one for each foundational market supported. The number of foundational markets may be determined by a platform operator or by bookmakers. The most common foundational market may be a full time score market.

When a bet is matched, bet parameters may be recorded in a matched bet database. The portfolio matrix 600 may be automatically populated and updated in real-time with bet specific data based on entries in the matched bet database. Individual cells identifying profitable outcomes from losing outcomes may be highlighted, such as cell 602. All bets may further be listed in a bet list window 610 with certain bet parameters, such as the outcome or market selection, the stake, the odds, the possible winnings, and the state of the bet, as described herein. A list or list window 610 may be provided with any matrix presented through the platform and may present data from the matrix in a list or alternate form with the same information, more information, or less information than what is shown in the matrix. In some embodiments, list data and matrix data may show only bets in a matched state. In some alternative embodiments, list data and matrix data for matrix embodiments described herein may show bets in different states, such as draft vs. matched bets, as would be understood by a person having ordinary skill in the art.

A portfolio matrix 600 may show or visualize all matched or settled bets for a game in a single matrix. Individual cells 602, 604 may be highlighted or colored to indicate or differentiate losing outcomes from winning outcomes. Settled bets and matched bets may further be distinguished by color or highlighting. Even bets on different markets may be summarized into the one matrix, as long as the markets can be based on the same foundational market. The comprehensive betting portfolio position, including multiple wagers, may be reconciled and presented through the matrix 600. A bet history list 610 may be provided, which may show the matrix data in list form and in varying levels of detail. List data may show bets in different states, such as settled vs. matched bets, as referenced above.

Now referring to exemplary FIG. 7, placing a individual outcome bet on a portfolio matrix may be shown. According to an exemplary embodiment, a bet may be placed through a portfolio matrix 700. This may combine or merge the capabilities of a bet history or portfolio page and bet placing page, all while utilizing the matrix format. The portfolio matrix 700 may show all matched and/or settled bets 702. Furthermore, a bet list 710 may be provided. A cell 704 of the matrix 700 may be engaged or clicked and the wagering platform may generate a draft bet based on the selection. The platform may generate and display a draft bet slip 730. The stake may be adjusted in the draft bet slip 730 and in some embodiments, the outcome selection and/or the odds may be presented on the draft bet slip 730. The draft bet slip 730 may include a reset button for resetting the default draft bet. Lastly, the draft bet slip 730 may include a Bet button or option for placing the bet. In some embodiments, the draft bet stage may be bypassed. In such embodiments, a bet slip may be generated and placed with a default stake when a matrix cell is selected. Once a bet placed through the matrix has been matched, the portfolio matrix may update in real-time as it is recalculated to include the newly matched bet data. One or more additional bets may be placed in the same way in simultaneous fashion.

Preview Matrix

Now referring to exemplary FIG. 8, placing a individual outcome bet on a preview matrix may be shown. All bets 802 for a game that are matched or settled may be displayed in a preview matrix, as also displayed in a portfolio matrix, but a preview matrix may further include drafted bets 804 in the matrix. Showing bet history or portfolio data in addition to draft bet data may show how a draft bet impacts odds, profits, and losses for all outcomes in light of previously matched and settled bets. Matched and settled bets 802 may be colored or highlighted and draft bets 804 may have a distinct color or highlight for further differentiation. When placing a bet through a portfolio matrix, matched bets may be shown in the matrix and draft bets may be shown only on a bet slip; however, a preview matrix may allow matched bets and draft bets to be calculated and displayed in the preview matrix, such that the profit, loss, and odds are calculated and presented as a preview of what the portfolio matrix will entail if the draft bet is placed and matched. The profit and loss presented in each cell may be a sum of the matched bets plus the draft bet. Therefore, if the profit or loss number for the matched bets on a matrix outcome is $100 and the drafted bet profit or loss for that outcome is $10, then the profit or loss for that cell in the preview matrix may be shown as the combined sum of $110. According to some exemplary embodiments, different color cells may be used for draft bets in a preview matrix in order to differentiate the profit or loss stemming from the draft bet from the profit or loss stemming from matched bets. In some alternative exemplary embodiments, a draft bet cell may be differentiated by showing both parts of the sum (e.g. “$100+$10”) instead of the combined profit or loss sum (e.g. “$110”).

Now referring to exemplary FIG. 9, multiple outcome betting on a preview matrix 900 may be provided. Multiple outcome betting on a preview matrix may allow a single bet on multiple outcomes as opposed to many bets on individual outcomes. Multiple cells 902, 904 on a preview matrix may be selected and the selected outcomes may be added to a single draft bet. The odds shown on a draft bet slip may be the combined odds for the single bet on multiple outcomes. Selections may be added or removed and the odds may be recalculated and updated in real-time based on the combination of selections. The stake may also be set or modified on a combined or aggregate basis, such that a user enters a stake for the combined bet. A placed multiple outcome bet (different from a multiples bet, as described above) may be a winning bet if any of the outcomes happen, which may be referred to as an “ANY-combo bet.” The calculation of odds for an ALL-combo bet or multiples bet may include multiplying the odds of the individual selections. The calculation of a single odds for an ANY-combo bet may require that the selections of the bet on different markets are first decomposed into corresponding outcomes on the same fundamental market. The probabilities of the decomposed selections may then be summed to result in a single combined odds for the ANY-combo bet.

Market Shortcuts

According to exemplary FIG. 10A-10C, platform may facilitate and process market shortcut betting. A preview matrix 1010 may be a matrix of individual outcomes, as described herein. In addition, platform may provide a match odds selection, which may, for example, include home win, draw, and away win. Furthermore, platform may provide a total goals selection. The match odds and total goals selection options may be market shortcuts, which may automatically select individual outcomes in the matrix based on market shortcut rules. For example, if home win is selected, all individual outcomes where the home team has a higher end score than the away team may be selected. Market shortcuts may impose a set of rules or algorithms, which trigger a set of selections to be made in accordance with those rules. As shown in FIG. 10B, additional selections or outcomes may be wagered. For example, in addition to selecting home win, an individual outcome selection or market shortcut may be added to the overall matrix selection and odds. Furthermore, individual outcome selections may be removed, including those that were individually selected or selected as part of a market shortcut. The odds on the bet slip may be updated in real time based on selected cells and may show the combined odds for a draft bet on all of the selected outcomes. The stake may further be modified. If satisfied, a bet may be placed or all selections may optionally be reset by a reset button. As shown in FIG. 10C, four outcomes from different markets may be selected and a market shortcut selection, 3-1, may be excluded. The set of included outcomes and excluded outcomes is called the bet selections. An example, in addition to that of FIG. 10C, may be “included outcomes: home win, under 22.5; excluded outcomes: 1-0.” The excluded outcomes may have priority over included outcomes, since excluded outcomes are selected for removal to override market shortcut automated selections. The bet may be a winning bet if any of the included outcomes occurs after the excluded outcomes have been removed. The bet may be an “ANY-combo bet.” When the platform processes selections for winners, an ANY-combo bet may be analyzed using an OR Boolean operator.

In some embodiments, outcome selections from different or unique markets may be combined in what is called an “ALL combo bet.” When the platform processes selections for winners, an ALL-combo bet may be analyzed using an AND Boolean operator. Therefore, a bet may only be a winning bet if all of the selected outcomes happen. For example, a user may select to include the outcomes Home Win, Under 2.5, and exclude the outcome 1-0. A bet may therefore only win if the game ends 2-0. The ALL-combo bet, just like the ANY-combo bet, may be limited to the set of outcomes on the same foundational market. Outcomes from different games for instance may not be combined in the same ALL-combo bet. The odds for an ALL combo bet may therefore be different from an ANY combo bet, even if the individual selections are the same.

Upon selection of market shortcut and/or individual outcomes in a matrix, the platform may create and present a draft bet slip, as described herein. When a bet slip is approved and a bettor places the bet, the platform may automatically generate a new bet slip data file, which may be saved in a database and/or transmitted to a bookmaker database for processing and/or matching. When a game or market ends, the bets on that market may become settled. Once a bettor has at least one matched bet, the platform may allow for cashing the unsettled bet, even if a game has not concluded. The cash-out may occur before the bet is settled or, in other words, before a winning outcome has been determined. For all matched, but unsettled bets, the platform may calculate a portfolio cash value for the whole. By calculating a cash value of the portfolio of unsettled bets, a single cash-out may be processed for multiple bets. The odds may be calculated based on progression of game parameters and the impact on winning probability. A bettor may optionally sell an entire game portfolio of matched bets to another party or to the bookmaker.

Draft-Bet Matrix

Now referring to exemplary FIG. 11, a draft-bet matrix 1100 may be provided. A draft-bet matrix may have a similar appearance to a preview matrix; however, a preview bet matrix may also show previously matched bets on a game. The platform may be switched between a draft-bet matrix and a preview matrix by selecting to hide matched bets on a preview matrix. The draft-bet matrix may show the profit and loss for individual outcomes and the odds for only the draft bet; however, in some embodiments, the draft-bet matrix may optionally still show the profit and loss for individual outcomes and the odds for the draft bet as an aggregate with the matched bets. A draft-bet matrix may allow a bettor, including novice bettors, to understand which outcomes correspond to a market selection. For example, a draft-bet matrix may show a bettor which score outcomes correspond to a bet on “4.5 Goals” or “Asian Handicap Home −0.25.” Furthermore, a draft-bet matrix may provide for a combined bet with a single odds. More specifically, a draft-bet matrix may facilitate placing a bet on a number of outcomes as a single bet with a single odds, which may be calculated by the platform.

Additional Features

Now referring to exemplary FIG. 12, a randomize bet function may be provided by the wagering platform. This may allow for playing a randomized game of chance on a specific game, which may create a thrill or interest in the game without requiring specific knowledge or selections. When a randomize bet function is input through a GUI, a random selection generator may be accessed by the platform and may select random individual outcomes and/or market selections. In some embodiments, the randomized selection may be presented to a bettor for further review and selection or exclusion. In other embodiments, the randomized selection may automatically place the bet by generating and transmitting a bet slip. In some exemplary embodiments, limits or parameters may be set on the random outcome generator. For example, a requested odds or approximation thereof may be adjustable before generating the random selection. Therefore, the random outcome generator or random selection generator may select outcomes that add up to the requested odds or a threshold thereof. The randomize bet function may be further limited to select outcomes by timing. In other words, outcomes expected or guaranteed within a time constrained interval may be selected. While a long interval may be anticipate, a short interval may typically be selected for a casino-style gaming experience. Example outcomes may include Next Goal, Number of Throw-Ins, Time of Next Goal. Other fast market outcomes may be used, such as Correct Score Minute 15 to 20, Number of Throw-Ins Minute 80 to 82, etc.

According to an exemplary embodiment, and referring to exemplary FIG. 13, a wagering platform component diagram may be provided. A front end interface 1310 of a wagering platform may facilitate placing a front end request, such as a try-trade or view status request. Front end 1310 may subscribe to games of interest and may receive updates of user interface state from a User State Manager 1320. Front end 1310 may also send requests to the User State Manager 1320 when a draft bet is changed and when a bet is placed. The User State Manager 1320 may receive updates from front end 1310 when a draft bet is changed or when a draft bet is placed, in which case User State Manager 1320 may forward the placed bet request to a trade engine 1350. User State Manager 1320 may receive updates from a game portfolio engine 1340 when a user portfolio has changed, including when a placed bet has been matched, or when odds for outcomes have changed. Select games may be subscribed-to for the purposes of receiving odds updates. A user state 1330 may also be maintained in association with the user state manager 1320. The following basic state may be kept up to date by the user state 1330, per user and per portfolio: draft bet, (user) portfolio, and odds for outcomes (of subscribed-to games). The basic state may include draft bet, user portfolio, odds for outcomes of subscribed-to games. Furthermore, if any of the basic state is updated, the following dependent user interface states may be recalculated and forwarded to the front end 1310: draft bet slip, draft matrix, bet history list, portfolio matrix, and preview matrix.

Trade engine 1350 may keep records of all placed bets for every game. Trade engine 1350 may validate placed bet requests and may be the gatekeeper before a placed bet is regarded as matched. Trade engine 1350 may forward matched bets to a global game portfolio. A wagering platform may have a game portfolio engine 1340. Every game may have its own game portfolio consisting of all matched or settled bets for a game by any user. The game portfolio engine 1340 may contain up-to-date probabilities for all outcomes in all games, which may be received from a probability engine 1360. The game portfolio engine may send updates to the user state manager 1320 when a user portfolio has changed or when odds for outcomes of subscribed-to games have changed. Probability engine 1360 may estimate the probability of any possible outcome of any market of any game. The probability engine may be independent from the rest of the wagering platform. In some embodiments, the probability engine 1360 may be a 3^{rd} party provider in full or in parts. The probability engine 1360 may send updates to a game probability engine whenever a probability changes.

Now referring to exemplary FIG. 14A-14B, a front end request may include a set of selections for a specific game and may be specific to a user or requester. Every selection in a set may have the binary option to be either included or excluded. The include or exclude option may be set as a master, such that the master selection (include or exclude) option always overrides the other option in a case of overlapping outcomes. A set of selections may be transformed from a set of selections that do not require mutual exclusivity to a set of outcomes. An outcome may be a specific point in a portfolio. The scope of a request may depend on its type, as either an idle or active request. An idle request may be a request that doesn't affect a static portion of a user portfolio. An active request may be a request that may be capable of adjusting the static portion of a user portfolio. An idle-request may go through a front and middle end of the platform, whereas an active request may go through a front, middle, and back end.

Now referring to exemplary FIG. 15, a user specific portfolio 1520, 1530 may be derived as a single entity from a global game portfolio 1510. This may provide a portfolio owner the ability to increase or decrease its position as a whole. A portfolio owner or user may change a position by making a selection. As shown in FIG. 16, an exemplary betting process for a single bet may be provided. The process may show a user specific portfolio matrix and preview matrix. An overall game portfolio matrix may also be shown for each stage to show how the individual user matrices relate to the overall game portfolio. According to the exemplary embodiment shown in FIG. 16, a simplified conceptual 2×2 matrix may be shown. The number sin a cell may include profit and probability odds, without added margin for purposes of clarity. A user may start with zero matched bets in the portfolio. The user may select one selection on a matrix and the wagering platform may generate a draft bet include a quoted odds. The draft bet may be presented or sent back to the user for review through a preview matrix. In the draft stage, the draft bet may have no effect on the user's portfolio matrix or the game portfolio. A user may decide to place the bet containing the single selection or may withdraw the selection. According to an exemplary embodiment, a user portfolio matrix and a game portfolio may be updated when the bet is matched.

A user may further have the option of placing multiple wagering selections, as shown in FIG. 17. A user may start with a matched bet from a single selection as described above. The user may mark two matrix outcomes, creating a draft bet with two matrix outcomes selected. The draft bet may include quoted odds and may be sent back to the user for review with a preview matrix. A user may accept the odds and place the bet or may withdraw the draft bet. If the user accepts and places the bet, and the placed bet is matched by the bookmaker, the matched bet may be added to the user's portfolio matrix and to the global game portfolio.

In still further exemplary embodiment and as shown in FIG. 18, a market shortcut selection option may be provided by the wagering platform. According to the example shown in FIG. 18, a user may start with zero matched bets in the portfolio matrix. The user may select a market shortcut option or button, such as Market Shortcut B, which may represent a combination of outcomes. A draft bet and preview matrix may be generated and sent back to the user for review with up-to-date odds. The preview matrix may show marked selections associated with the market shortcut combination. A user may optionally remove individual selections placed by the market shortcut selection or may further add selections to those made by the market shortcut selection. The platform may generate and update the odds and price in real time, as various selections are input. As shown in FIG. 18, a user may mark one more matrix outcome selection, which wasn't already included in the previously marked market shortcut. An updated draft bet and preview matrix may then be generated and sent back to the user for review with up-to-date odds. When satisfied with the totality of the selections, a draft bet may be placed or withdrawn. Once a placed bet is matched, it may be moved to the user portfolio.

In still further exemplary embodiments, as shown in FIG. 19, a wagering platform may provide for a sell portfolio option or selection. In this case, a bet or multiple bets may have already been matched for the current game and a bettor may wish to sell the portfolio of matched bets. As shown in FIG. 19, a user may click to sell portfolio and a quoted price or portfolio value may be returned to the user to review. The user may decline the price and retain the matched bet portfolio or the user may accept the price and a payout may be made to the user. According to an exemplary embodiment, a sell portfolio selection may automatically process which additional selections would be required to cancel a bettor's risk. The cost for making the necessary selections may be processed based on the necessary additional selections and may be presented to a bettor. The bettor may accept the price and upon acceptance a payout to the bettor or user may be made.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A non-transitory computer-readable medium for managing wagers, comprising instructions stored thereon, that, when executed on a processor, perform the steps of:
generating a bet matrix for a game, wherein the bet matrix comprises individual cells representing possible outcomes of game events;
displaying the bet matrix through a user interface;
calculating current odds for at least one outcome occurring wherein calculating current odds comprises retrieving real-time information comprising at least one of current game state data and current game statistics, comparing the retrieved real-time information to existing information and determining whether the odds for any outcomes have changed, ending a real-time update when odds have not changed for any outcomes;
processing an input of a selection of at least one cell;
processing input of a stake;
automatically calculating a profit or loss for each outcome based on the selection, the stake, and the odds;
presenting the profit or loss for each outcome in a respective cell;
processing and presenting odds for the selection in real-time, wherein the odds are based on the game;
creating a bet slip, wherein the bet slip includes at least one bet selection;
processing a place bet instruction;
placing a bet according to the bet slip;
creating a placed bet record;
creating a combined bet portfolio for a foundational market comprising all placed bets from a user based on the foundational market merged into one collection;
calculating a comprehensive bet position reconciling multiple bets for each cell and associated game outcome;
updating the odds in real time for previously placed bets in the combined bet portfolio based on a live game state and updating the comprehensive bet position; and
displaying the bet matrix with an updated, live profit or loss associated with each cell of the bet matrix based on the comprehensive bet position.

2. The non-transitory computer readable medium of claim 1, further comprising providing at least one market shortcut and processing selection of at least one cell by selection of at least one market shortcut, wherein the at least one market shortcut creates a single bet comprising all selections meeting a market shortcut rule.

3. The non-transitory computer readable medium of claim 1, further comprising presenting a draft-bet matrix displaying profit, loss and odds for a selection of outcomes.

4. The non-transitory computer readable medium of claim 1, further comprising generating at least one bet slip comprising a random selection generated by a random outcome selection generator and placing a bet with the at least one random selection.

5. The non-transitory computer readable medium of claim 4, further comprising processing adjustments to the random selection from user interface input, updating odds in real-time based on the adjustments, and placing a bet upon instruction from user interface input.

6. (canceled)

7. The non-transitory computer readable medium of claim 1, wherein the combined bet portfolio has a single estimated cash value derived from individual bets merged into the collection, wherein the single estimated cash value is calculated from a payout and real-time probability.

8. The non-transitory computer readable medium of claim 7, wherein the combined bet portfolio is salable according to the real-time single estimated cash value.

9. The non-transitory computer readable medium of claim 7, wherein the combined bet portfolio is divisible into partial portfolios.

10. The non-transitory computer readable medium of claim 1, wherein the bet comprises inclusion and exclusion selections.

11. The non-transitory computer readable medium of claim 10, wherein one of inclusion selections or exclusion selections is treated as a master.

12. A non-transitory computer-readable medium for managing wagers, comprising instructions stored thereon, that, when executed on a processor, perform the steps of:
generating a portfolio matrix for a game, wherein the portfolio matrix comprises individual cells representing possible outcomes of game events;
displaying the portfolio matrix through a user interface;
determining matched bet cells of the portfolio matrix identifying matched bet outcomes based on matched bet records;
differentiating the matched bet cells from non-matched bet cells;
automatically calculating potential profit or loss for each outcome based on the matched bet records;
presenting the potential profit or loss for each outcome in a respective cell;
processing and presenting odds for all matched bet outcomes, wherein the odds are based on the game;
creating a combined bet portfolio for a foundational market comprising all placed bets from a user based on the foundational market merged into one collection;
calculating a comprehensive bet position reconciling multiple bets for each matched bet cell and associated game outcome;
updating the odds in real time for previously matched bets in the combined bet portfolio based on a live game state and updating the comprehensive bet position, wherein updating the odds comprises retrieving real-time information comprising at least one of current game state data and current game statistics, comparing the retrieved real-time information to existing information and determining whether the odds for any outcomes have changed, ending a real-time update when odds have not changed for any outcomes; and
displaying the portfolio matrix with an updated, live potential profit or loss associated with each cell of the bet matrix based on the comprehensive bet position.

13. The non-transitory computer readable medium of claim 12, wherein the matched bet cells comprise matched bet outcomes from more than one matched bet.

14. The non-transitory computer readable medium of claim 12, further comprising:
processing an input of a selection of at least one cell;
processing input of a stake;
calculating a profit or loss for each outcome based on the selection, the stake, the odds, and the matched bet records;
presenting the profit or loss for each outcome in a respective cell;
processing and presenting current odds for the selection in real time, wherein processing current odds comprises retrieving real-time information comprising at least one of current game state data and current game statistics, comparing the retrieved real-time information to existing information and determining whether the odds for any outcomes have changed, ending a real-time update when odds have not changed for any outcomes;
creating a bet slip, wherein the bet slip includes at least one bet selection;
processing a place bet instruction;
placing a bet according to the bet slip; and
creating a placed bet record.

15. The non-transitory computer readable medium of claim 8, wherein the real-time single estimated cash value is based on progression of game parameters and an associated impact on winning probability.

16. The non-transitory computer readable medium of claim 1, wherein the bet matrix comprises at least 16 cells.

17. The non-transitory computer readable medium of claim 1, wherein the combined bet portfolio for a foundational market comprises all bets from at least two of a money line market, a handicap market, a total points market, a winner market, and a correct score market.
